(19) United States
(12) Patent Application Publication
(10) Pub. No.: US 2017/0041530 A1
(43) Pub. Date: Feb. 9, 2017

(54) INFORMATION PROCESSING APPARATUS AND CONTROL METHOD THEREFOR

(71) Applicant: CANON KABUSHIKI KAISHA, Tokyo (JP)

(72) Inventor: TAKUMI KIMURA, Tokyo (JP)

(21) Appl. No.: 15/217,318

(22) Filed: Jul. 22, 2016

(30) Foreign Application Priority Data
Aug. 4, 2015 (JP) 2015-154499

(51) Int. Cl. H04N 5/232

(52) U.S. Cl. CPC H04N 5/23216; H04N 5/23206; H04N 5/23238; H04N 5/23296

(57) ABSTRACT

This invention makes it possible to readily and correctly confirm the available range of each of the pan and tilt of a network camera, which is allowed for a general user. An apparatus according to this invention sets, in a network camera for which each of a pan angle and tilt angle is changeable, the available range of each of pan and tilt operable by the general user. If the field of view of a video received from the network camera includes the boundary of the available range, a line segment representing the boundary of the available range is superimposed within the received video.

### BACKGROUND OF THE INVENTION

Field of the Invention

The present invention relates to an information processing apparatus and a control method therefor.

Description of the Related Art

A network camera uses viewable range setting. This limits the image capturing capable range of the camera, and is used in a case in which the user wants to limit zoom or part of a field of view when disclosing a live video.

Japanese Patent Laid-Open No. 2013-157905 describes a method in which while capturing images of a plurality of aspect ratios, the entire viewable range region can be captured without capturing the outside of the available viewable range in any image.

The administrator of the network camera sets the viewable range of the camera. The administrator has the authority capable of moving the camera outside the viewable range. The administrator can set the viewable range by designating the right and left ends of the pan, upper and lower ends of the tilt, and the telephoto and wide angle ends of the zoom.

As a setting method, there is provided a method of moving the pan and tilt positions of the camera by slider bars and the like, and acquiring and saving the positions as the left and upper ends when determining the upper left position of the viewable range.

After determining the boundary position of the viewable range, the administrator operates the orientation of the camera, and confirms whether the viewable range region is as estimated. However, it is difficult to discriminate between the inside and outside of the viewable range on the live video of the camera. For example, there is a problem that after determining the upper left boundary position, it is difficult to confirm at any pan position whether the upper end has been correctly set.

### SUMMARY OF THE INVENTION

The present invention solves the above problem, and provides a technique capable of readily and correctly confirming the available range of each of the pan and tilt of the network camera, which is allowed for a general user.

According to an aspect of the invention, there is provided an information processing apparatus for setting, in a network camera for which each of a pan angle and tilt angle is changeable, an available range of each of pan and tilt operable by a user, comprising: a setting unit configured to set the available range of the network camera; and a display control unit configured to display a video received from the network camera, wherein if a field of view of the received video includes a boundary of the available range set by the setting unit, the display control unit superimposes a line segment representing the boundary of the available range within the received video.

According to the present invention, it is possible to readily and correctly confirm the available range of each of the pan and tilt of a network camera, which is allowed for a general user.

Further features of the present invention will become apparent from the following description of exemplary embodiments (with reference to the attached drawings).

### BRIEF DESCRIPTION OF THE DRAWINGS

FIG. 1 is a view showing the configuration of a network camera system according to an embodiment;

FIG. 2 is a block diagram showing a network camera;

FIG. 3 is a block diagram showing a client apparatus;

FIG. 4 is a view showing an example of a user interface according to the first embodiment;

FIG. 5 is a view showing an example of a user interface according to the second embodiment;

FIGS. 6A and 6B are views each showing an example of a user interface according to the third embodiment;

FIG. 7 is a flowchart illustrating the processing procedure of the network camera according to the embodiment;

FIG. 8 is a flowchart illustrating the processing procedure of the client apparatus according to the first embodiment; and

FIG. 9 is a flowchart illustrating the processing procedure of the client apparatus according to the first embodiment.

### DESCRIPTION OF THE EMBODIMENTS

Embodiments of the present invention will be described in detail below with reference to the accompanying drawings.

### First Embodiment

In the first embodiment, an example in which the position of a boundary selected as a viewable range is displayed on a live video of a camera will be explained.

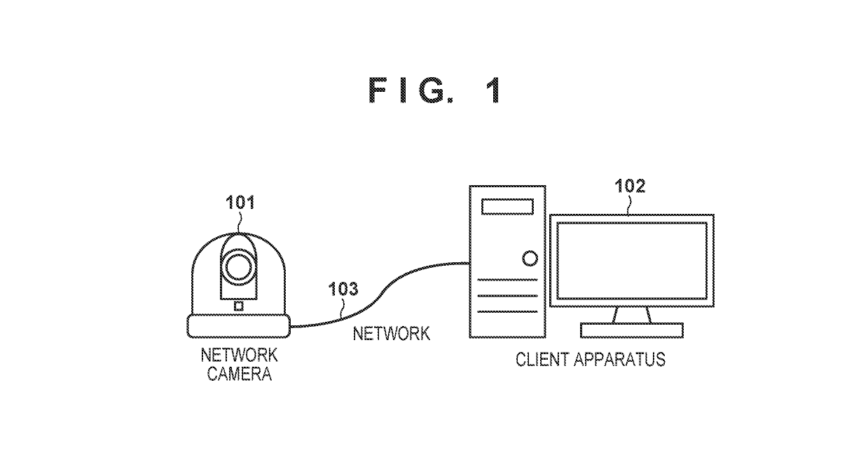

FIG. 1 is a view showing the schematic configuration of a network camera system according to the first embodiment. Referring to FIG. 1, the network camera system includes a network camera 101 for delivering live video information via a network. Each of the pan angle and tilt angle of the network camera 101 can be changed by a remote operation. A remote operation can also be performed for the zoom ratio of the network camera 101 according to the embodiment. This system includes a client apparatus 102 for displaying a video from the network camera 101, and performing a remote operation by transmitting various commands to the network camera 101 in accordance with instructions from the user. The network camera 101 and the client apparatus 102 are connected by a network 103 capable of performing IP-based communication, such as a LAN or the Internet.

Any digital network such as the Internet or an Intranet with a band enough to pass a camera control signal and a compressed image signal may be adopted as the network 103. Note that a TCP/IP (UDP/IP) protocol is assumed as a network protocol.

For the sake of descriptive simplicity, FIG. 1 shows one network camera 101 and one client apparatus 102. However, the number of connected devices is not specifically limited. Note that the client apparatus 102 is illustrated as that used by the user having the administrative authority. Assume that IP addresses are assigned to all of the network cameras 101 and the client apparatuses 102.

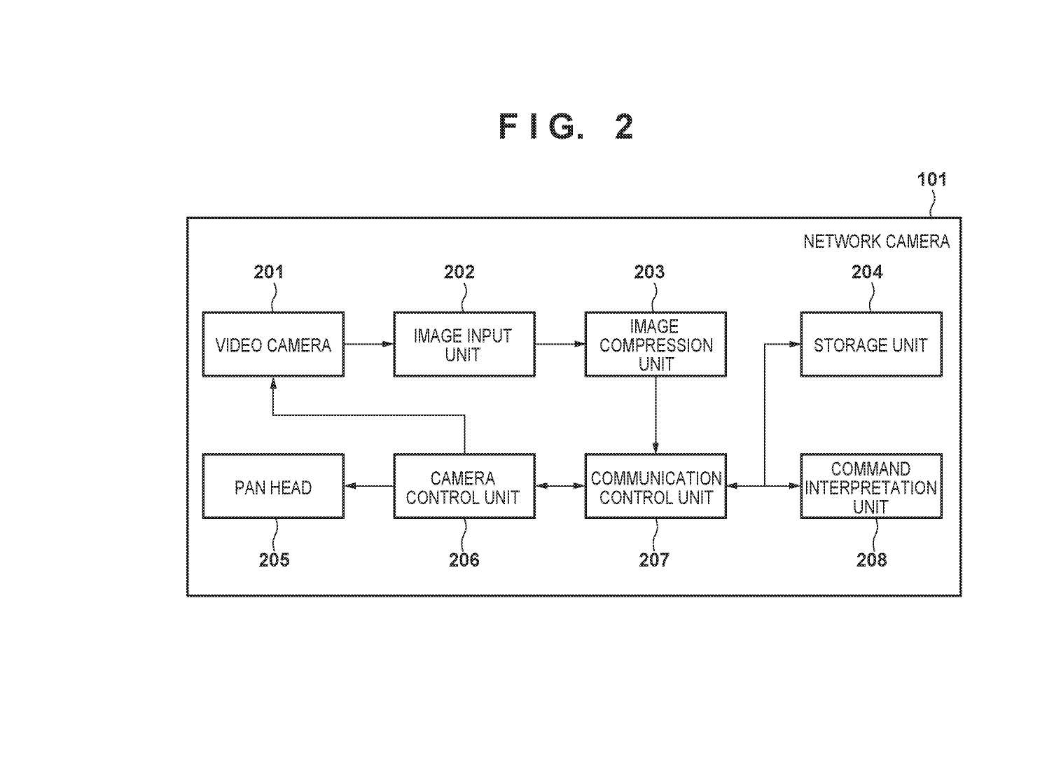

FIG. 2 is a block diagram showing the internal arrangement of the network camera 101 shown in FIG. 1.

The network camera 101 has the following components including a camera control unit 206 for controlling the overall apparatus.

A communication control unit 207 performs processing of receiving various commands from the client apparatus 102, and processing of distributing video data to the client apparatus 102. If the communication control unit 207 receives a command from the client apparatus 102, it transfers the command to a command interpretation unit 208 to convert it into information in a format interpretable by the camera control unit 206.

A video camera 201 captures a video in accordance with a zoom ratio instructed by the camera control unit 206, and outputs the captured video. An image input unit 202 acquires the captured video (moving image and still image) obtained by the video camera 201. If images of 30 frames are acquired per sec, it is possible to acquire a moving image of 30 fps. An image compression unit 203 compresses the acquired captured image to a data size which is readily distributed to the client apparatus. Note that after acquiring an image signal from the video camera 201, and performing A/D conversion, the image compression unit 203 compresses the converted signal by Motion JPEG, and transfers the compressed signal to the communication control unit 207. As a result, the communication control unit 207 distributes the image data to the network 103 which the camera has logged in to. In this example, Motion JPEG is exemplified as a video compression method but the type of compression method is not specifically limited. A pan head 205 incorporates the video camera 201, and can change the pan angle in the horizontal direction and the tilt angle in the vertical direction under the control of the camera control unit 206.

A storage unit 204 stores and holds various setting values (including viewable range information), an administrator ID and password, and data such as panoramic images. In the embodiment, the setting information of the viewable range stored in the storage unit 204 is information for defining the available range of each of the pan, tilt, and zoom which can be performed by a general user other than the administrator. Note that if the network camera 101 has no zooming function, the upper and lower limits of the zoom ratio are not necessary.

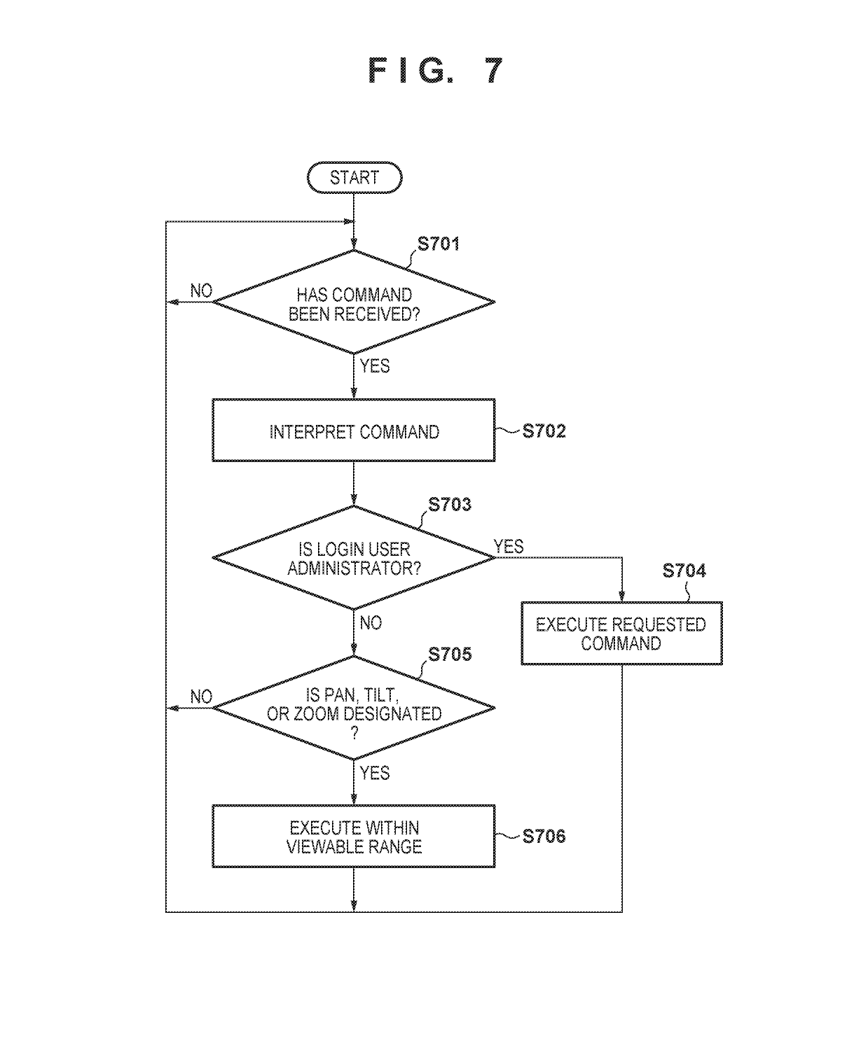

The processing of the camera control unit 206 when the network camera 101 with the above arrangement according to the embodiment receives various commands from the client apparatus will be described with reference to a flowchart shown in FIG. 7. Note that FIG. 7 shows processing after the end of login processing by the client apparatus 102. Image distribution processing is apparent from the above processing, and is performed as another thread, and a detailed description thereof will be omitted. The flowchart shown in FIG. 7 is implemented when the CPU of the client apparatus 102 executes a program read out into a RAM.

In step S701, the camera control unit 206 waits for reception of a command via the communication control unit 207. If it is determined that a command has been received, the camera control unit 206 uses, in step S702, the command interpretation unit 208 to interpret the received command. In step S703, it is determined whether the user of the transmission source of the command has logged in using the administrative authority. If the user has logged in as an administrator, the process advances to step S704. Even if a request to change the angle of view of the camera is a request corresponding to an image of a region outside a preset viewable range, processing according to the request is executed. That is, the administrator can use all the functions of the network camera 101.

On the other hand, if it is determined in step S703 that the user of the command request source is not an administrator but a general user, the process advances to step S705. In step S705, the camera control unit 206 determines whether the requested command is a change instruction command for one of the pan angle, tilt angle, and zoom ratio. This is done because among the functions of the network camera 101 according to the embodiment, functions usable by the general user are those of changing the pan angle, tilt angle, and zoom ratio. Thus, no request for a function other than the usable functions is accepted. If the request is a change instruction command for one of the pan angle, tilt angle, and zoom ratio, the process advances to step S706. In step S706, the camera control unit 206 changes the pan angle, tilt angle, or zoom ratio within the allowable range in the viewable range information stored in the storage unit 204. For example, if the viewing field of the requested pan angle exceeds the viewable range, the viewing field is limited to the pan angle matching the boundary of the viewable range. The same applies to the tilt angle and the zoom ratio.

Note that the processing in step S704 when the login user is an administrator includes a change instruction of the pan angle, tilt angle, or zoom ratio. In this case, there is no limitation based on the stored setting information of the viewable range. Other processes include a request to acquire the value of the current pan angle, tilt angle, or zoom ratio, a request to acquire the viewable range information stored in the storage unit 204, a viewable range information update request, a panoramic image acquisition request, and a panoramic image generation request. If the request to acquire the value of the pan angle, tilt angle, or zoom ratio is received, the camera control unit 206 returns the requested current value. This function is prepared for confirmation when the administrator issues a request to change a zoom ratio of 1 to 33 10 of the network camera 101 to ×20. If the viewable range information acquisition request or the panoramic image acquisition request is received, the camera control unit 206 only transmits the corresponding information stored in the storage unit 204 to the client apparatus which the administrator has logged in to, which need not specifically be described. If the viewable range update request is received, the camera control unit 206 receives, as new “viewable range”, the information following the command, and performs storage (overwrite) processing in the storage unit 204.

If the request is a panoramic image generation request, the camera control unit 206 repeats processing of maximizing the zoom ratio (setting the zoom ratio to the telephoto end), respectively changing the pan angle and tilt angle by preset angles, and capturing an image. The camera control unit 206 performs processing of connecting the captured images to generate one panoramic image of the image capturing capable range of the network camera 101, and storing the panoramic image in the storage unit 204. Note that the user who has logged in by the administrative authority may issue, using the client terminal, a command of instructing to change the pan angle, tilt angle, or zoom ratio, as needed, and generate a panoramic image by compositing the received images. In this case, the client apparatus transmits an upload request command and the generated panoramic image to the network camera 101, thereby storing the image in the storage unit 204.

The arrangement and processing contents of the network camera 101 according to the embodiment have been explained. The arrangement and processing contents of the client apparatus 102 according to the embodiment will be described next.

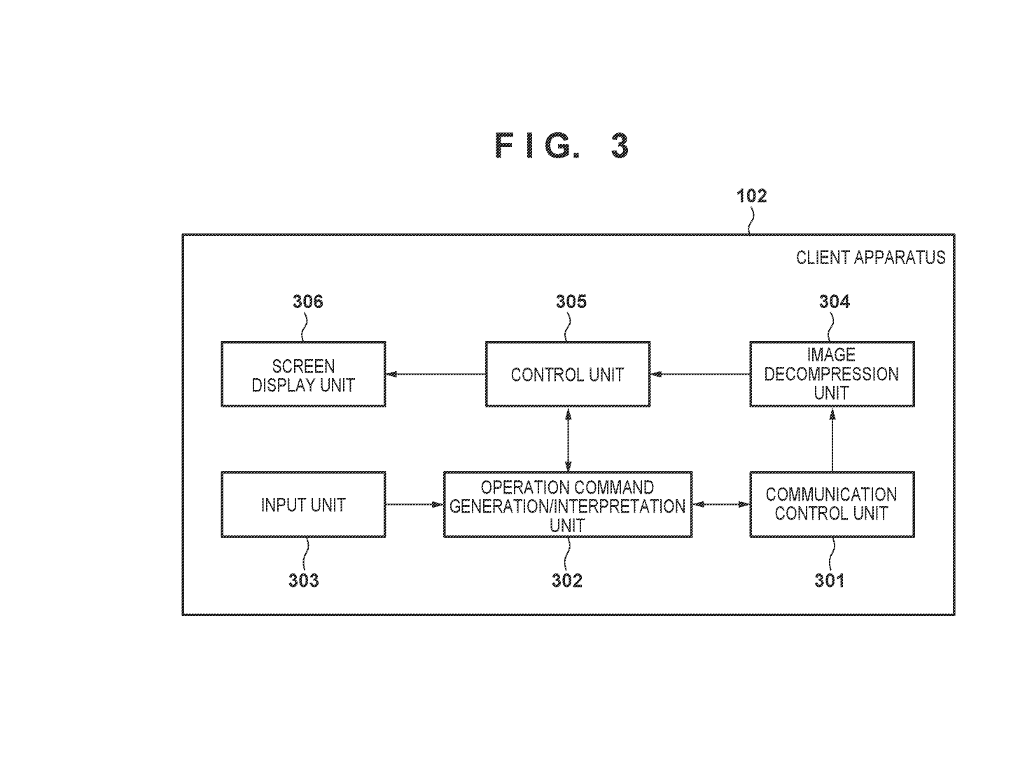

FIG. 3 is a block diagram showing the internal arrangement of the client apparatus 102 shown in FIG. 1. The client apparatus 102 can be connected to the arbitrary network camera 101 by designating the IP address assigned to each network camera. A communication control unit 301 is formed by a circuit that receives captured video data transmitted from the network camera 101, and the panoramic image data and viewable range information held in the storage unit 204. The communication control unit 301 also performs command transmission processing to the network camera 101, and processing of receiving state information as the result of the command transmission processing.

A control unit 305 controls the overall apparatus, and is formed by a CPU for executing processing in accordance with a readout program, and a RAM for storing a program read out from a hard disk. For example, the control unit 305 generates a captured video and panoramic image expanded (decoded) by an image decompression unit 304, and a graphical user interface (GUI) from the results of various camera operations. The control unit 305 displays the generated images and GUI on a screen display unit 306 formed by a liquid crystal display or the like. Note that if a plurality of network cameras are connected, it is possible to display the plurality of cameras on one screen or select one of the cameras. An input unit 303 is formed by a keyboard and a pointing device such as a mouse or touch panel, and can be used to designate a command for determining the operation of the network camera and its parameters. An operation command generation/interpretation unit 302 generates various camera operation commands based on GUI operations. The communication control unit 301 transmits the generated various camera operation commands to the network camera 101. The operation command generation/interpretation unit 302 performs processing of interpreting a camera operation result received from the network camera 101, and transferring the result to the control unit 305. As hardware, the operation command generation/interpretation unit 302 may be implemented by the same processor as the CPU for implementing the control unit 305, or by a different processor. The image decompression unit 304 may be implemented by a dedicated decoder circuit, or implemented when the CPU executes an image decompression program.

The hardware arrangement necessary for the client apparatus 102 is the same as that of an information processing apparatus such as a general personal computer (PC), and some or all of the functions shown in FIG. 3 can be implemented as software provided in the form of a storage medium such as a CD-ROM.

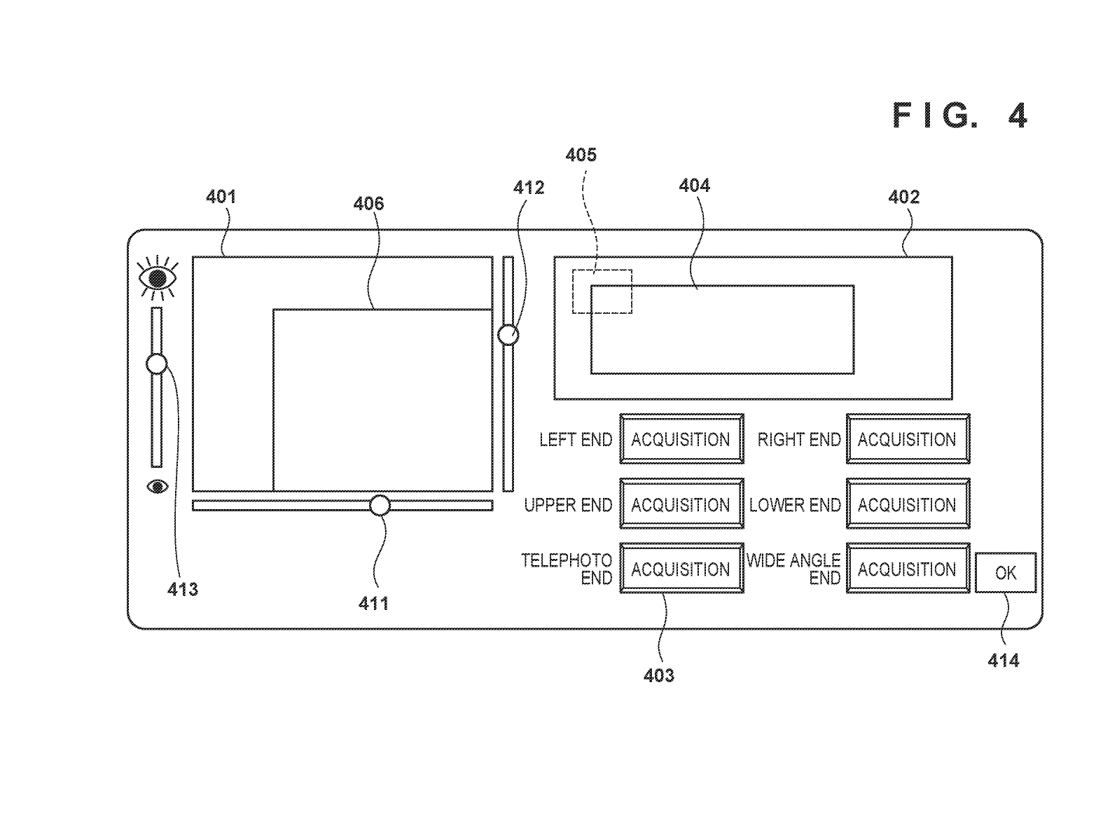

FIG. 4 shows a user interface while the client apparatus 102 according to this embodiment executes an application for the administrator of the network camera. The following description assumes that the user has already logged in to the network camera 101 as an administrator by inputting the administrator ID and password. This user interface is also displayed on the screen display unit 306. Note that the user interface of an application executed by a general user other than the administrator has only a region for displaying an image received from the network camera 101, and parts for setting the pan angle, tilt angle, and zoom ratio, and a description thereof will be omitted.

The application for the administrator also serves as software (program) for setting or changing the viewable range of the network camera 101. The viewable range defines an allowable range when the general user other than the administrator performs a remote operation for the network camera 101 via the terminal apparatus of the user, as already described. In other words, the viewable range is used by the general user to set the allowable ranges of the right and left ends of the pan position and the upper and lower ends of the tilt position of the pan head 205, and the telephoto end (tele end) and wide angle end (wide end) of the zoom position of the video camera 201. By setting the available viewable range, a field of view in which the general user can perform image capturing using the network camera 101 can be limited.

The available viewable range is set by the administrator of the network camera 101. Therefore, the user having the administrative authority for setting the available viewable range (the user who has logged in using the administrator ID and password) can use all the functions of the network camera 101, and is not limited with respect to an operation by the available viewable range.

Referring to FIG. 4, a video display unit 401 is a region where the whole of the currently captured video received from the network camera 101 is displayed. An outer boundary box indicated by the video display unit 401 can represent a boundary box indicating the viewing field of the network camera 101 which currently performs image capturing. The user operates controls such as slider bars 411, 412, and 413 on the screen using the input device such as a mouse or touch panel while viewing, on the video display unit 401, the video being captured by the network camera. Note that the slider bar 411 is a control for controlling the pan angle, the slider bar 412 is a control for controlling the tilt angle, and the slider bar 413 is a control for controlling the zoom ratio.

A panoramic display unit 402 displays the panoramic image received from the network camera 101. The panoramic image is one image obtained by connecting images over the entire pan/tilt movable range of the pan head 205 of the network camera 101. By creating a panoramic image in advance, the image can be used on client software such as a viewer. If no panoramic image has been created, a black background image or the like is displayed on the panoramic display unit 402 so that the user can know that no panoramic image has been created. If a panoramic image has been created, the panoramic image read out from the storage unit 204 of the network camera is displayed on the panoramic display unit 402.

A panoramic image is generated by providing a panoramic image creation instruction from a menu (not shown) of an administrative application (administrator). Upon providing the panoramic image creation instruction, the administrative application issues a panoramic image generation request command to the login network camera 101. The camera control unit 206 of the network camera 101 generates a panoramic image in accordance with the above-described procedure, and stores the panoramic image in the storage unit 204. The panoramic image stored in the storage unit 204 is held unless a panoramic image generation command is received again. The panoramic display unit 402 shown in FIG. 4 displays the panoramic image received from the network camera 101.

A boundary box 404 for setting the viewable range, which is displayed on the panoramic display unit 402, is generated by the application of the client apparatus 102 based on the viewable range information received from the network camera 101.

The user can change the position and size of the boundary box 404 for setting the viewable range y operating the input device. For example, if the mouse is dragged in a region inside the boundary box 404 for setting the viewable range, the position of the entire viewable range can be moved without changing the shape. If the mouse is dragged on one of the left, right, upper, and lower sides of the boundary box 404 for setting the viewable range, the position of a corresponding one of the left, right, upper, and lower ends of the viewable range can be changed. If the mouse is dragged on the upper left vertex of the boundary box 404 for setting the viewable range, the positions of the left and upper ends of the viewable range can be simultaneously changed. The upper right, lower left, and lower right vertices can also be operated in the same manner.

A method of changing the size and position of the boundary box 404 for setting the viewable range is not limited to the above one. The user can set the upper, lower, right, and left ends of the field of view of the camera displayed on the video display unit 401 to the boundary positions of the viewable range of the viewable range by operating the current position acquisition operation unit 403. For example, if the “acquisition button” of the left end of the current position acquisition operation unit 403 is clicked, the left end of the video displayed on the video display unit 401 is set as the left end of the boundary box indicating the viewable range. The left side of the boundary box 404 for setting the viewable range of the panoramic display unit 402 is moved so as to match the left side of a boundary box 405 for displaying the current position with respect to the position in the horizontal direction. The same applies to the right, upper, and lower ends. If the telephoto end is clicked, a ratio at which the video is displayed on the video display unit 401 is set as the telephoto end (maximum ratio) settable by the general user of the network camera 101. If the wide angle end is clicked, the ratio at which the video is displayed on the video display unit 401 is set as the wide angle end (minimum ratio) settable by the general user of the network camera 101.

If the user sets the viewable range by the above-described method, he/she may desire to confirm whether the viewable range is correctly set. Although the user can perform confirmation to some extent by the boundary box 404 for setting the viewable range, which is displayed on the panoramic display unit 402, the resolution of the panoramic image is low, and thus it is difficult to perform fine confirmation on only the panoramic display unit 402. The user must want to confirm on the video display unit 401 whether the current position falls within the viewable range while operating the pan or tilt but it is difficult to grasp the boundary of the viewable range.

In this embodiment, viewable range boundary lines 406 are superimposed on the video display unit 401. The viewable range boundary lines 406 correspond to part of the boundary box 404 for setting the viewable range, which is displayed on the panoramic display unit 402. The viewable range boundary lines 406 are displayed at positions corresponding to the current pan angle, tilt angle, and zoom ratio (or focal length), and are relatively moved by operating the pan, tilt, or zoom. By seeing the viewable range boundary lines 406, the user can readily confirm, at a resolution much higher than that of the panoramic image, whether the viewable range has been correctly set. If the user finally clicks an OK button 414, a viewable range update request command and information indicating the viewable range set as described above are transmitted to the network camera 101.

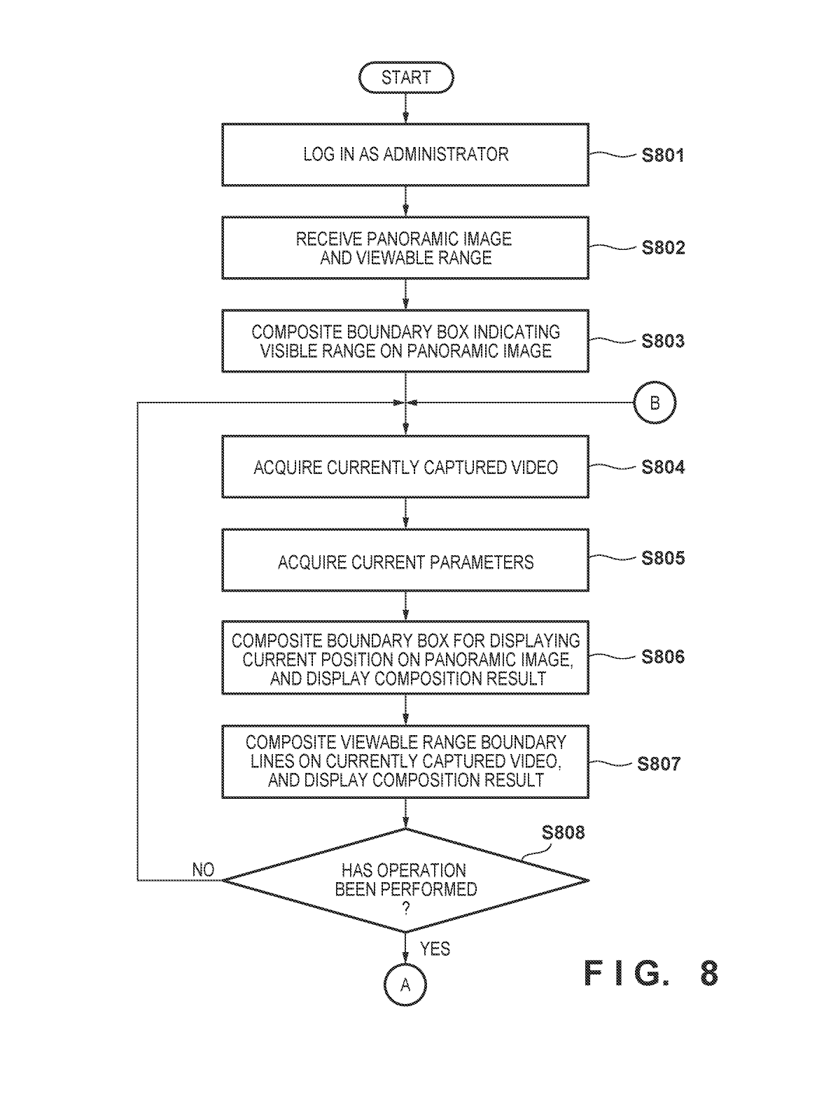

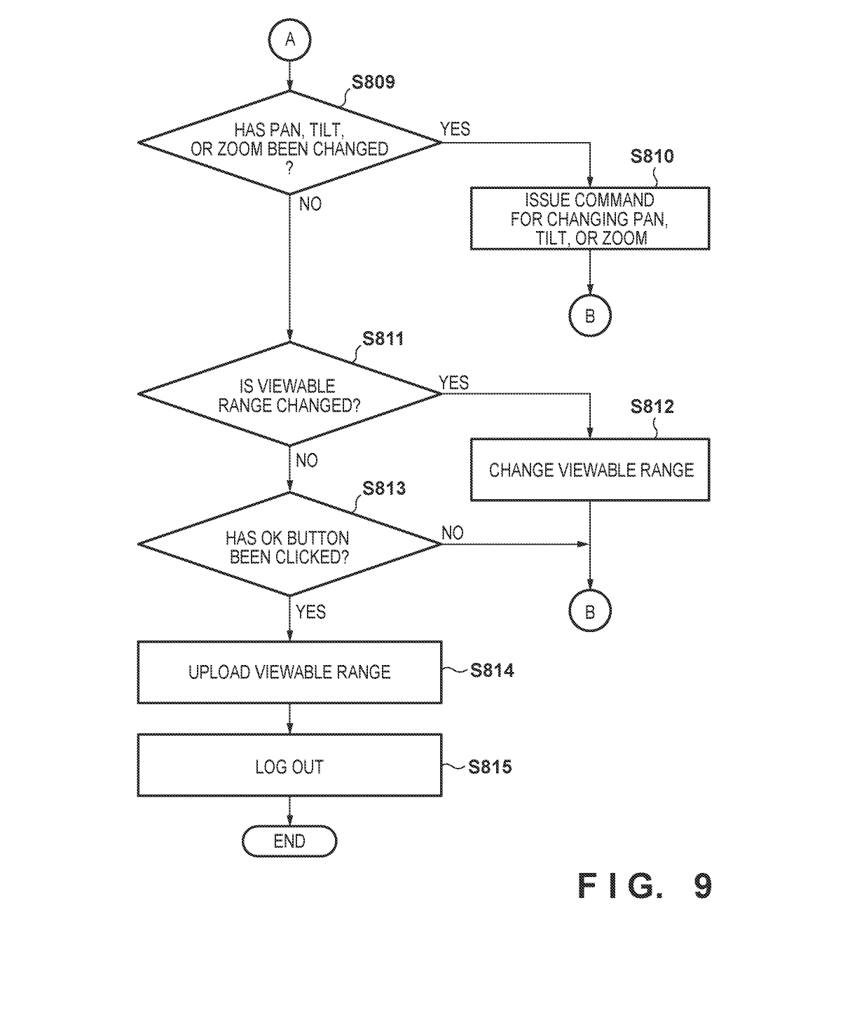

The display control processing by the control unit 305 when executing the application for the administrator according to the embodiment will be described again with reference to FIG. 4 and flowcharts shown in FIGS. 8 and 9. The flowcharts shown in FIGS. 8 and 9 are implemented when the CPU of the client apparatus 102 executes a program read out into the RAM.

In step S801, the control unit 305 logs in to the network camera 101 as an administrator using the administrator ID and password. If the control unit 305 successfully logs in, commands of respectively requesting the network camera 101 of the currently set viewable range and the panoramic image are issued to acquire the pieces of information from the network camera 101 in step S802.

In step S803, the control unit 305 generates, from the received information indicating the viewable range, the boundary box 404 for setting the viewable range, and superimposes the boundary box 404 for setting the viewable range on the received panoramic image. In step S804, the video currently captured by the network camera 101 is received. In step S805, the pan angle, tilt angle, and zoom ratio at that time are acquired. In step S806, the control unit 305 further composites, on the panoramic image having undergone the composite processing in step S803, the boundary box for displaying the current position based on the acquired pan angle, tilt angle, and zoom ratio, and displays the composition result on the panoramic display unit 402. In step S807, the control unit 305 composites, on the current video, the viewable range boundary lines as part of the boundary box for displaying the current position, and displays the composition result on the video display unit 401.

As a result, the user interface shown in FIG. 4 is displayed on the screen display unit 306.

In step S808, the control unit 305 determines the presence/absence of the operation of the current position acquisition operation unit 403, the OK button 414, or one of the slider bars 411 to 413, or the presence/absence of the movement or modification operation of the boundary box 404 for setting the viewable range.

If it is determined that no operation has been performed, the process returns to step S804. Therefore, as long as no operation is performed, a video substantially in real time is displayed on the video display unit 401. If the boundary box 404 for setting the viewable range exists in the field of view of the camera, the viewable range boundary lines 406 as the boundary lines of the boundary box are also displayed.

If the user has operated one of the slider bars 411 to 413, the control unit 305 determines that the operation has been performed, and advances the process from step S809 to step S810. In step S810, processing of issuing a command and parameters corresponding to the position of the slider bar (one of the slider bars 411 to 413) operated by the user, and transmitting them to the network camera 101 are performed. The process then returns to step S804. For example, if the slider bar 411 has been operated, a pan angle change command including, as an argument, the position of the knob of the slider bar after the operation is transmitted. As a result, the network camera 101 controls the pan head 205 in accordance with the request, thereby changing the pan angle. The network camera 101 transfers, to the client apparatus 102, the video based on the changed pan angle. As described above, the control unit 305 receives the video in step S804, and receives the current parameters in step S805. Consequently, in steps S806 and S807, the boundary box 405 for displaying the current position on the display screen is changed, and the relative positions of the viewable range boundary lines 406 are also changed along with a change in the line-of-sight direction or enlargement ratio of the camera.

If the user has sent an instruction to change the position and shape of the boundary box 404 for setting the viewable range or has operated the current position acquisition operation unit 403, the control unit 305 determines in step S811 that the operation has been performed. Therefore, if the user has performed such operation, the control unit 305 changes the viewable range in step S812. The control unit 305 returns the process to step S804. As a result, the boundary box 404 for setting the viewable range and the viewable range boundary lines 406 on the display screen are also changed.

Assume that the user clicks the OK button 414. In this case, the control unit 305 determines the presence of the operation in step S813, and performs processing in step S814. In step S814, the control unit 305 transmits, to the network camera 101, the viewable range update request command and the information indicating the viewable range (corresponding to the boundary box for setting the viewable range) when operating the OK button 414. If the network camera 101 receives the command from the user having the administrative authority, it considers to have received information indicating a new viewable range, and writes (overwrites) it in the storage unit 204.

The embodiment has been explained. According to the above embodiment, when setting a viewable range (pan angle range, tilt angle range, or zoom ratio range) within which the general user can operate the network camera 101, line segments indicating the boundary of the viewable range are superimposed on a currently captured video. As a result, it becomes possible to readily confirm whether a region where the viewable range has been set is correct, for example, the position of the boundary of the viewable range or whether a target object falls within the viewable range.

### Second Embodiment

The second embodiment is an example obtained by developing the above-described first embodiment.

According to the above-described first embodiment, if the vertical and horizontal lines are superimposed as viewable range boundary lines within the current viewing field displayed on the video display unit 401, that is, if one of the four corners of the viewable range falls within the current viewing field, it is possible to discriminate between the inside and outside of the viewable range. However, if there is one boundary line or no boundary line is seen, it is difficult to know whether the video displayed on the video display unit 401 falls within or outside the viewable range. Therefore, the user performs determination based on the relationship between the boundary box 404 for setting the viewable range and the boundary box 405 for displaying the current position on the panoramic display unit 402.

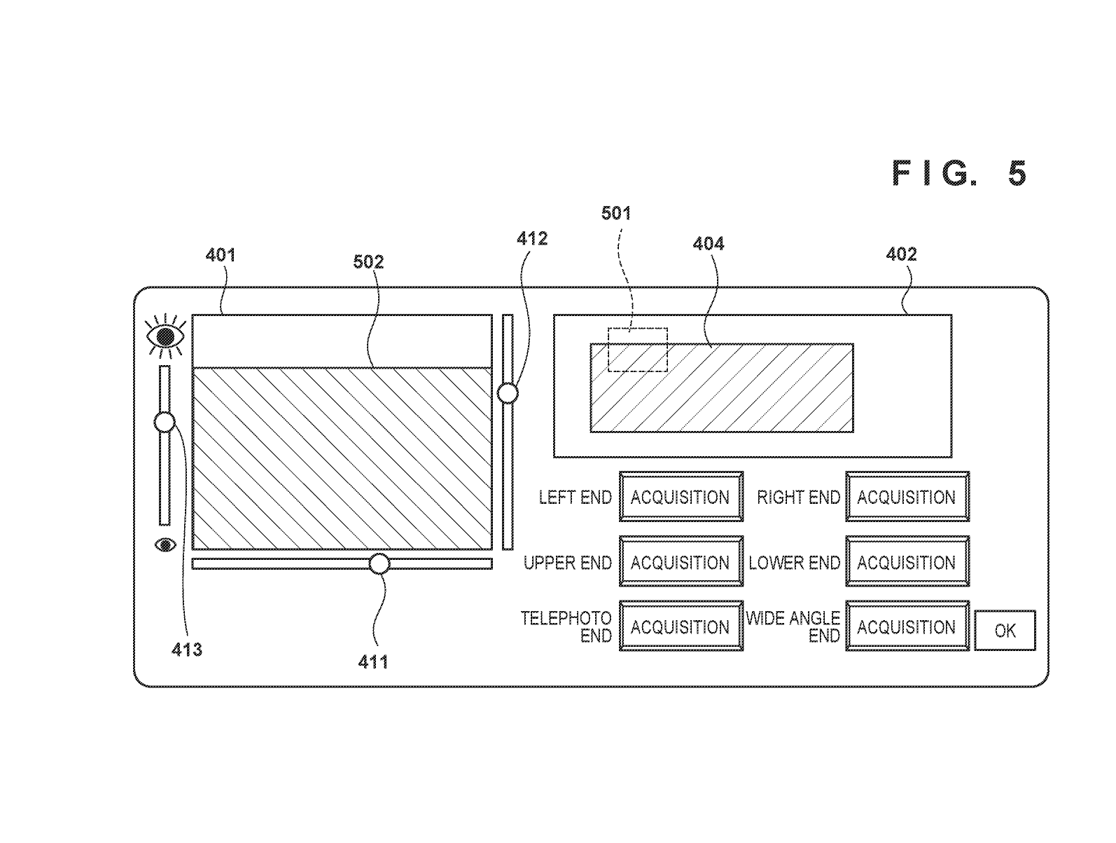

In the second embodiment, different display methods are used for the inside and outside of a viewable range. For example, the inside of a boundary box 404 for setting a viewable range is hatched. Similarly, a region within the viewable range of a viewable range boundary line 502 is hatched. FIG. 5 shows an example. As a result, even if a boundary box 501 for displaying the current position is at a position shown in FIG. 5, the user can recognize which side of the viewable range boundary line 502 falls within the viewable range by seeing only a video display unit 401.

In the second embodiment, the region within the viewable range is hatched. Any method may be adopted as long as it is possible to discriminate between the inside and outside of the viewable range. For example, a method of displaying, inside the viewable range, a letter or icon indicating the inside of the viewable range or a method of setting a viewable range boundary line of two colors and using the different colors for the inside and outside may be adopted.

As described above, using the user interface of the client apparatus according to the second embodiment, it is possible to readily determine whether the position where image capturing is currently performed falls within or outside the viewable range.

### Third Embodiment

The third embodiment will describe a method of moving a camera to a corresponding position when changing a viewable range in a panoramic image displayed on a user interface.

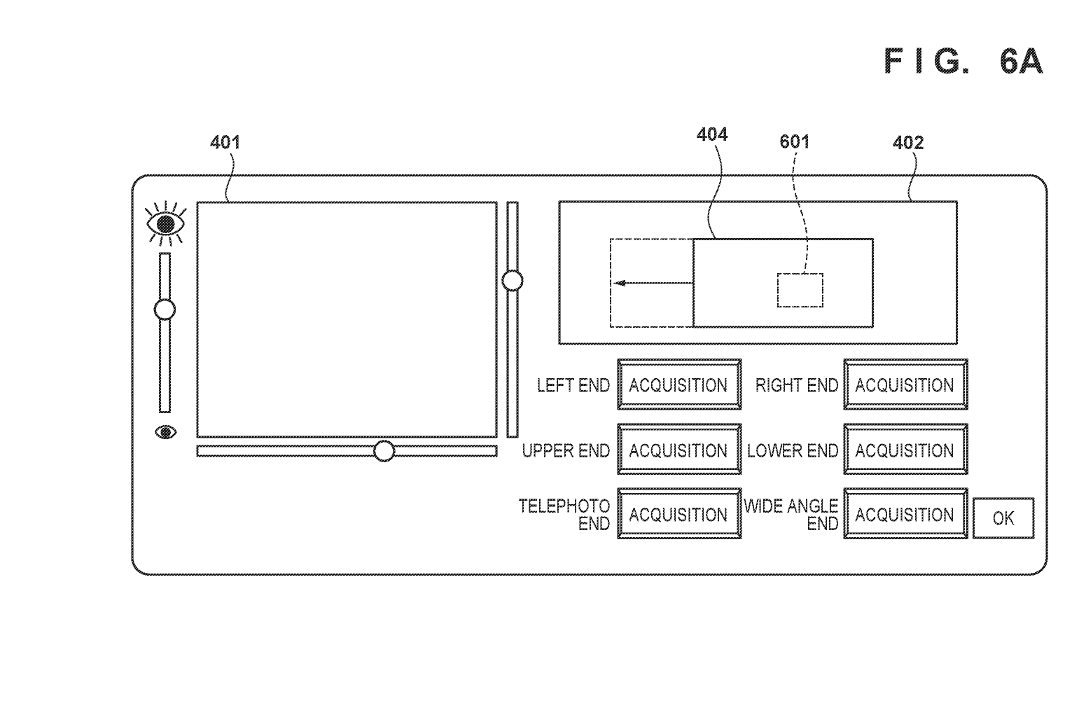

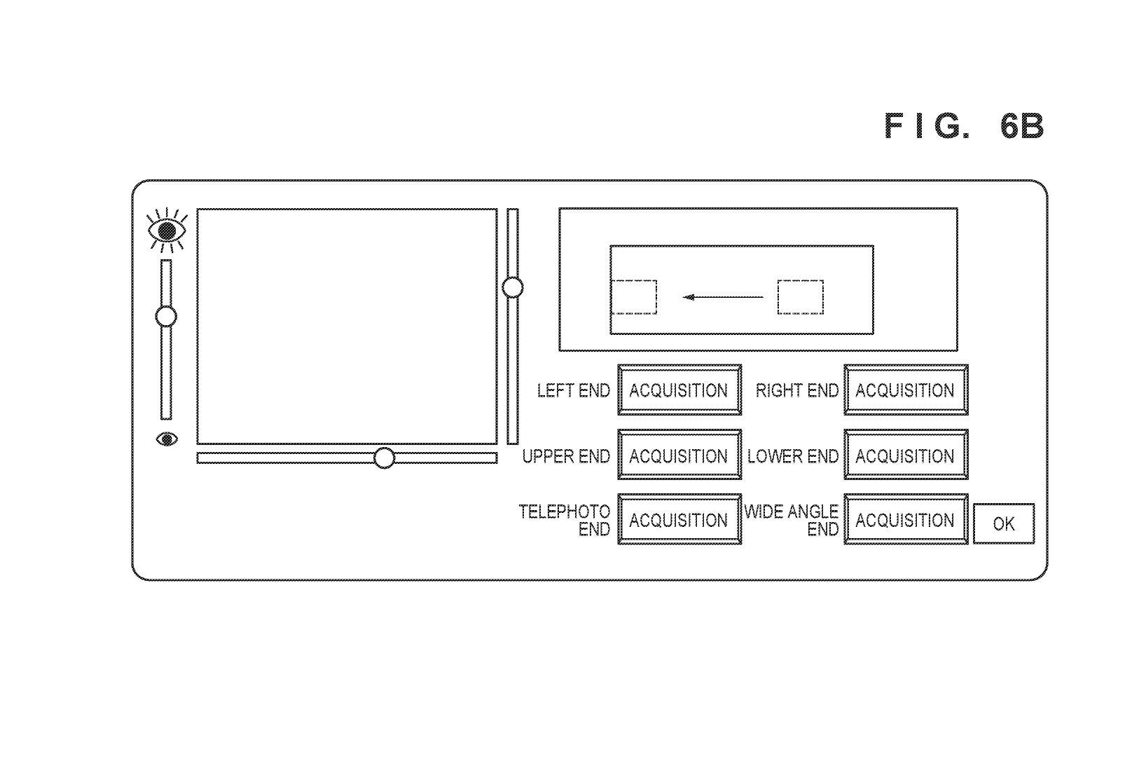

FIGS. 6A and 6B are views each showing an example of a screen displayed on a screen display unit 306 of a client apparatus 102 to which a user interface is applied according to the third embodiment.

As described in the first embodiment, the user can change the size of the boundary box 404 for setting the viewable range by operating the input device. In the third embodiment, when changing the size of a boundary box 404 for setting a viewable range, the pan angle and/or tilt angle is changed to set the boundary position of the changed viewable range at the current field end of the camera. This processing corresponds to processing in steps S812 of FIG. 9 to step S804.

Assume that a mouse is dragged on the left side of the boundary box 404 for setting the viewable range to change the position, as shown in FIG. 6A. In this case, the left end position of the viewable range is changed. At this time, as shown in FIG. 6B, the pan angle of the camera is changed so that a boundary box 601 for displaying the current position, that is, the left end of the angle of view of the camera matches the left end of the viewable range. It is not always necessary to match the boundary box 601 with the left end of the viewable range when changing the pan angle/tilt angle of the camera. The pan angle/tilt angle of the camera is changed to display a position corresponding to a changed portion. Note that in addition to the pan angle of the camera, the tilt angle may be changed to that corresponding to the position to which the mouse has been dragged. This is because the user is interested in the drag position at a high possibility.

Similarly, if the position is changed by dragging the mouse on the right side of the boundary box 404 for setting the viewable range, the pan angle of the camera is changed so that the right end of the angle of view of the camera matches the right end of the viewable range. Note that the tilt angle may be changed to that corresponding to the position to which the mouse has been dragged, similarly to the processing for the left end of the viewable range.

If the position is changed by dragging the mouse on the upper side of the boundary box 404 for setting the viewable range, the tilt angle of the camera is changed so that the upper end of the angle of view of the camera matches the upper end of the viewable range. If the position is changed by dragging the mouse on the lower side of the boundary box 404 for setting the viewable range, the tilt angle of the camera is moved so that the lower end of the angle of view of the camera matches the lower end of the viewable range. In addition to the tilt angle of the camera, the pan angle may be changed to that corresponding to the position to which the mouse has been dragged.

If the mouse is dragged at one of the four corners, for example, the upper left corner of the boundary box 404 for setting the viewable range to change the position of the corner, both the tilt angle and the pan angle of the camera are changed so that the upper left corner of the angle of view of the camera matches the upper left corner of the changed viewable range. The same applies to the remaining corners.

Note that the condition for changing the pan angle and tilt angle of the camera is not limited to a case in which the position or size of the boundary box 404 is changed. For example, when the left side of the boundary box 404 for setting the viewable range is clicked, the pan position of the camera may be moved.

A method of changing the viewable range is not limited to the method of operating the boundary box 404 for setting the viewable range. For example, a method may be adopted in which the viewable range is changed by adding knobs indicating the upper and lower limits of the pan and tilt to the pan and tilt sliders, and changing the position of each knob.

Range change targets are not limited to the pan and tilt of the camera, and may be zoom and a rotation angle.

This embodiment targets software for setting the viewable range but can be used for any function as long as an operation of selecting a partial region from the image capturing capable range of the camera using panoramic display is performed. For example, the embodiment can be used for a function of selecting a region where a panoramic image is to be created.

As described above, when changing the setting of the viewable range, it is possible to readily confirm the setting using the user interface of the client apparatus according to this embodiment. Although the preferred embodiments of the present invention have been explained, the present invention is not limited to them, and various modifications and changes can be made within the spirit and scope of the present invention.

The panoramic image generation method according to the present invention is preferable when the viewable range of the network camera is set.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-154499, filed Aug. 4, 2015, which is hereby incorporated by reference herein in its entirety.

What is claimed is:

1. An information processing apparatus for setting, in a network camera for which each of a pan angle and tilt angle is changeable, an available range of each of pan and tilt operable by a user, comprising:
a setting unit configured to set the available range of the network camera; and
a display control unit configured to display a video received from the network camera,
wherein if a field of view of the received video includes a boundary of the available range set by the setting unit, the display control unit superimposes a line segment representing the boundary of the available range within the received video.

2. The apparatus according to claim 1, further comprising:
a panoramic display unit configured to superimpose, on a panoramic image which is obtained by connecting a plurality of images captured within a range where each of the pan angle and tilt angle of the network camera is changeable and represents an image capturing capable range of the network camera, a boundary box representing the available range and a boundary box indicating a viewing field, which represents the field of view currently captured.

3. The apparatus according to claim 2, wherein
the display control unit displays the inside and outside of the available range in different forms in the video received from the network camera, and
the panoramic display unit displays the inside and outside of the boundary box representing the displayed available range in different forms.

4. The apparatus according to claim 2, wherein the setting unit sets a position and size which indicate the available range by changing, in accordance with a user instruction, a position and size of the boundary box representing the available range displayed on the panoramic display unit.

5. The apparatus according to claim 2, further comprising:
a change unit configured to change, if a position of a boundary line representing the boundary box is changed to change a size of the boundary box representing the available range displayed on the panoramic display unit, one of the pan and tilt of the network camera to the position of the changed boundary line.

6. The apparatus according to claim 1, wherein the setting unit includes
a first setting unit configured to set a left end of the field of view of the video received from the network camera as a left end of the available range,
a second setting unit configured to set a right end of the field of view of the video received from the network camera as a right end of the available range,
a third setting unit configured to set an upper end of the field of view of the video received from the network camera as an upper end of the available range, and
a fourth setting unit configured to set a lower end of the field of view of the video received from the network camera as a lower end of the available range.

7. The apparatus according to claim 1, further comprising:
an operation unit configured to operate a zoom ratio of the network camera in accordance with an instruction from a user,
wherein the setting unit further sets an available range of zoom operable by the general user.

8. The apparatus according to claim 7, wherein the setting unit includes
a fifth setting unit configured to set the field of view of the video received from the network camera at a wide end of the zoom within the available range, and
a sixth setting unit configured to set the field of view of the video received from the network camera at a tele end of the zoom within the available range.

9. A control method for an information processing apparatus for setting, in a network camera for which each of a pan angle and tilt angle is changeable, an available range of each of pan and tilt operable by a user, comprising:
setting the available range of the network camera; and
displaying a video received from the network camera,
wherein in the displaying, if a field of view of the received video includes a boundary of the available range, a line segment representing the boundary of the available range is superimposed within the received video.

10. A non-transitory computer-readable storage medium storing a program which causes a computer to perform the steps of a method of setting, in a network camera for which each of a pan angle and tilt angle is changeable, an available range of each of pan and tilt operable by a user, the method comprising:
setting the available range of the network camera; and
displaying a video received from the network camera,
wherein in the displaying, if a field of view of the received video includes a boundary of the available range, a line segment representing the boundary of the available range is superimposed within the received video.

11. An information processing apparatus for setting, in a network camera for which each of a pan angle and tilt angle is changeable, an available range of each of pan and tilt operable by a user, comprising:
a display control unit configured to display a video received from the network camera;
a panoramic display unit configured to display, on a panoramic image which is obtained from a plurality of images captured by the network camera, an area representing the available range;
a setting unit configured to set the available range of the network camera by changing a boundary line of the area displayed on the panoramic image; and
a control unit configured to control a change of, if a position of a boundary line of the area is changed, at least one of the pan and tilt of the network camera corresponding to the changed position of the boundary line.

12. The apparatus according to claim 11, wherein a viewing field representing the field of view currently captured is displayed.

13. The apparatus according to claim 11, wherein the display control unit displays an inside and outside of the area in different forms in the video received from the network camera.

14. The apparatus according to claim 11, wherein the position of the boundary line is changed in accordance with a user instruction.

15. A control method for an information processing apparatus for setting, in a network camera for which each of a pan angle and tilt angle is changeable, an available range of each of pan and tilt operable by a user, comprising:
setting the available range of the network camera;
displaying a video received from the network camera;
displaying, on a panoramic image which is obtained from a plurality of images captured by the network camera, an area representing the available range;
setting the available range of the network camera by changing a boundary line of the area displayed on the panoramic image; and
controlling a change of, if a position of a boundary line of the area is changed, one of the pan and tilt of the network camera corresponding to the changed position of the boundary line.

16. The method according to claim 15, wherein a viewing field representing the field of view currently captured is displayed.

17. The method according to claim 15, wherein an inside and an outside of the area is displayed in different forms in the video received from the network camera.

18. The apparatus according to claim 15, wherein the position of the boundary line is changed in accordance with a user instruction.

19. A non-transitory computer-readable storage medium storing a program which causes a computer to perform the steps of a method of setting, in a network camera for which each of a pan angle and tilt angle is changeable, an available range of each of pan and tilt operable by a user, the method comprising:
setting the available range of the network camera;
displaying a video received from the network camera;
displaying, on a panoramic image which is obtained from a plurality of images captured by the network camera, an area representing the available range;
setting the available range of the network camera by changing a boundary line of the area displayed on the panoramic imaue; and
controlling a change of, if a position of a boundary line of the area is changed, one of the pan and tilt of the network camera corresponding to the changed position of the boundary line.
